(19) United States
(12) Patent Application Publication
(10) Pub. No.: US 2003/0177375 A1
(43) Pub. Date: Sep. 18, 2003

(54) Apparatus for regenerating a copy-protected signal cross-reference to related applications

(76) Inventor: Masaki Tsuji, Fukaya-shi (JP)

Correspondence Address: PILLSBURY WINTHROP, LLP, P.O. BOX 10500, MCLEAN, VA, 22102, US

(21) Appl. No.: 10/347,493

(22) Filed: Jan. 21, 2003

(30) Foreign Application Priority Data
Jan. 21, 2002 (JP) 2002-012011

(51) Int. Cl. H04L 9/32

(52) U.S. Cl. 713/189

(57) ABSTRACT

An apparatus for regenerating a copy-protected signal comprises a decoding module including a decoding section configured to decode a copy-protected signal, and a first control section configured to control the decoding section, and a unit including a signal processing section configured to process a signal decoded by the decoding section, and a second control section configured to control the signal processing section, the first control section permitting a decoding operation by the decoding section when the self-holding identification information corresponds with identification information preset in the second control section.

### CROSS-REFERENCE TO RELATED APPLICATIONS

This application is based upon and claims the benefit of priority from the prior Japanese Patent Application No. 2002-012011, filed Jan. 21, 2002, the entire contents of which are incorporated herein by reference.

### BACKGROUND OF THE INVENTION

1. Field of the Invention

The present invention relates to an apparatus for regenerating a copy-protected signal, which receives a copy-protected signal, and decodes (removes) copy protection so that the copy-protected signal can be regenerated. In particular, the present invention relates to improvement of an apparatus including a built-in decoding module for decoding copy protection as a set.

2. Description of the Related Art

As publicly known, in systems transmitting information signals to many users, a transmission signal is copy-protected in order to prevent illegal copy of the information signal, and a receiver decodes copy protection so that the signal can be regenerated.

For example, Jpn. Pat. Appln. KOKAI Publication No. 2000-358227 discloses a copy-protect system for analog video signals other than standard NTSC (National Television System Committee) video signals.

The above copy-protect system scrambles a non-NTSC video signal, and prepares key information for decoding the scramble or information for verifying a connected side.

Exchange of key information and authentication information is made between a sender (source device) and a receiver (sync (synchronous) device), and thereby, it is determined whether or not scramble decoding of analog video signals is permitted in the sync device.

The copy-protect system comprises a decoding module for removing the copy protect. The module is an external adaptor to the existing AV (Audio Visual) apparatuses. It is connected to an AV apparatus by RCA pins or the like.

In order to prevent the decoding module from being used for illegal copy, if the decoding module is once attached to AV devices, and thereafter, detached, a copy-protect removal function is lost.

Nowadays, sync devices having a copy-protect removal module built in a module set are appearing. However, present measures to prevent the removal module built in the sync device from being used for illegal copy are inadequate.

Jpn. Pat. Appln. KOKAI Publication No. 2000-4433 discloses the technique of confirming authentication for each functional module in a personal computer, and limiting digital contents usable for each functional module.

However, the above Publication has no description relevant to measures for preventing the copy-protect removal module built in the above sync device from being used for illegal copy.

### BRIEF SUMMARY OF THE INVENTION

The present invention has been proposed in view of the above circumstances. Therefore, it is an object of the present invention to provide an apparatus for regenerating a copy-protected signal, which can prevent a copy-protect removal module built in the apparatus from being used for illegal copy.

According to one aspect of the present invention, there is provided an apparatus for regenerating a copy-protected signal, comprising:

a decoding module including a decoding section configured to decode a copy-protected signal, and a first control section configured to control the decoding section; and

a unit including a signal processing section configured to process a signal decoded by the decoding section, and a second control section configured to control the signal processing section,

the first control section permitting a decoding operation by the decoding section when the self-holding identification information corresponds with identification information preset in the second control section.

### BRIEF DESCRIPTION OF THE SEVERAL VIEWS OF THE DRAWING

FIG. 1 is a block diagram to explain the configuration of an apparatus for regenerating a copy-protected signal according to a first embodiment of the present invention;

FIG. 2 is a flowchart to explain the features of the operation of the apparatus in the first embodiment;

FIG. 3A and FIG. 3B are flowcharts to explain an apparatus for regenerating a copy-protected signal according to a second embodiment of the present invention;

FIG. 4 is a flowchart to explain an apparatus for regenerating a copy-protected signal according to a third embodiment of the present invention; and

FIG. 5 is a block diagram to explain the configuration of an apparatus for regenerating a copy-protected signal according to a fourth embodiment of the present invention.

### DETAILED DESCRIPTION OF THE INVENTION

[First Embodiment]

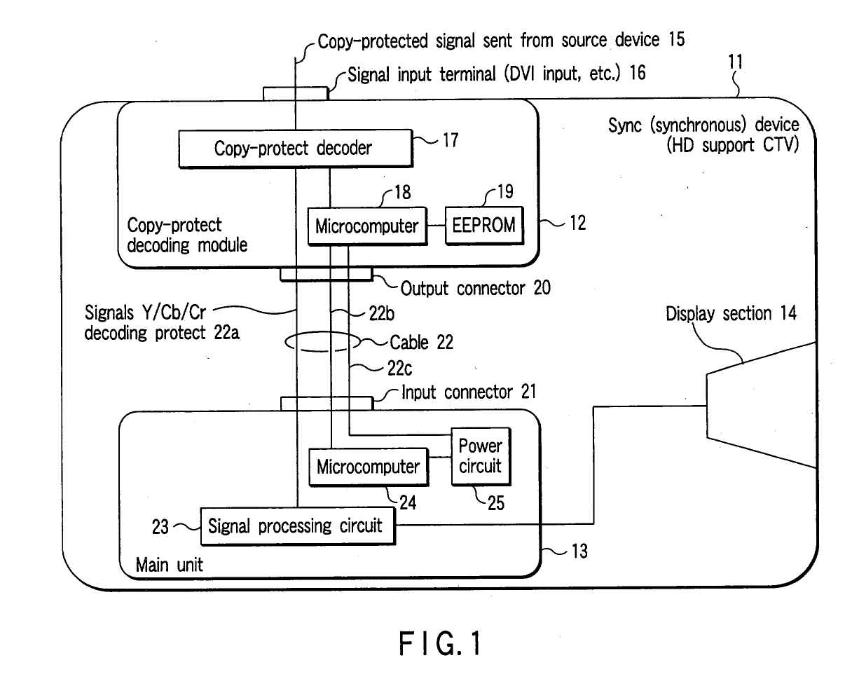

The first embodiment of the present invention will be described below with reference to the accompanying drawings. FIG. 1 shows the entire configuration of a sync (synchronous) device 11, which will be described in the first embodiment.

The sync device 11 includes a color television receiver (CTV) support for high vision (HD), a projection TV (PJTV), a liquid crystal projector TV (LCD-PJTV), etc. By way of the above sync device, the CTV will be described hereinafter.

The sync device 11 mainly comprises a copy-protect decoding module 12, a main unit 13, and a display section 14. The main unit 13 is arranged after the copy-protect decoding module 12, and carries out signal processing and the power control of the whole sync device 11. The display unit 14 displays a signal processed by the main unit 13.

The display section 14 is a CRT (Cathode Ray Tube), a liquid crystal display panel, etc. As the case may be, the main unit 13 is divided into two or three, depending on the sync device 11. Here, one main unit 13 is represented for simplification.

The signal flows in the following manner. First, a copy-protected signal 15 from a source device (not shown) is supplied to a signal input terminal 16 of the sync device 11. The copy-protected signal 15 is, for example, a digital visual interface (DVI) signal, etc. The signal input terminal 16 is a DVI input terminal if the copy-protected signal is a DVI signal.

The copy-protected signal 15 thus supplied to a signal input terminal 16 is inputted to a copy-protect decoder 17 constituting the copy-protect decoding module 12. The copy-protect decoder 17 carries out copy-protect decoding and digital/analog conversion if the input signal is digital. Here, for simplification, it is called a copy-protect decoder 17.

The copy-protect decoding module 12 mainly comprises the above copy-protect decoder 17, a microcomputer 18 and an EEPROM (Electrically Erasable and Programmable Read Only Memory 19). The copy-protect decoding module 12 is built into the rear side corresponding to the signal input terminal 16 in the sync device 11, and covered with a shield.

In particular, if the copy-protected signal 15 thus supplied to a signal input terminal 16 is a digital-transmitted DVI signal, high-speed and wideband transmission is made. For this reason, preferably, the copy-protect decoding module 12 has the circuit configuration integrated with the signal input terminal 16 as much as possible. In this case, it is desirable that the copy-protect decoding module 12 shields noise radiation to the outside. In the first embodiment, there is no illustration with respect to the shield for the copy-protect decoding module 12.

In the first embodiment, a cable 22 connects the copy-protect decoding module 12 and the main unit 13 via an output connector 20 and an input connector 21.

The cable 22 connecting the copy-protect decoding module 12 and the main unit 13 includes a signal line 22a, a control line 22b and a power supply line 22c. The signal line 22a is used for supplying a signal in which copy protection is removed by the copy-protect decoder 17 to a signal processing circuit 23 of the main unit 13. The control line 22b connects a microcomputer 18 included in the copy-protect decoding module 12 and a microcomputer 24 included in the main unit 13. The power supply line 22c is used for supplying the power from a power circuit 25 included in the main unit 13 to the copy-protect decoding module 12.

The above signal in which copy protection is removed by the copy-protect decoder 17 is, for example, Y/Cb/Cr signals, etc. These signals are outputted from the copy-protect decoding module 12, and sent to the main unit 13.

In this case, users can guess that the copy-protect decoding module 12 has a copy-protect decoding function, based on the form of the module 12 and the display of the signal input terminal 16. Based on this, it is possible for a malicious user to open the cabinet of the sync device 11 so that the copy-protect decoding module 12 can be detached, and then connected to external recording equipment, and thereby, to make illegal copies.

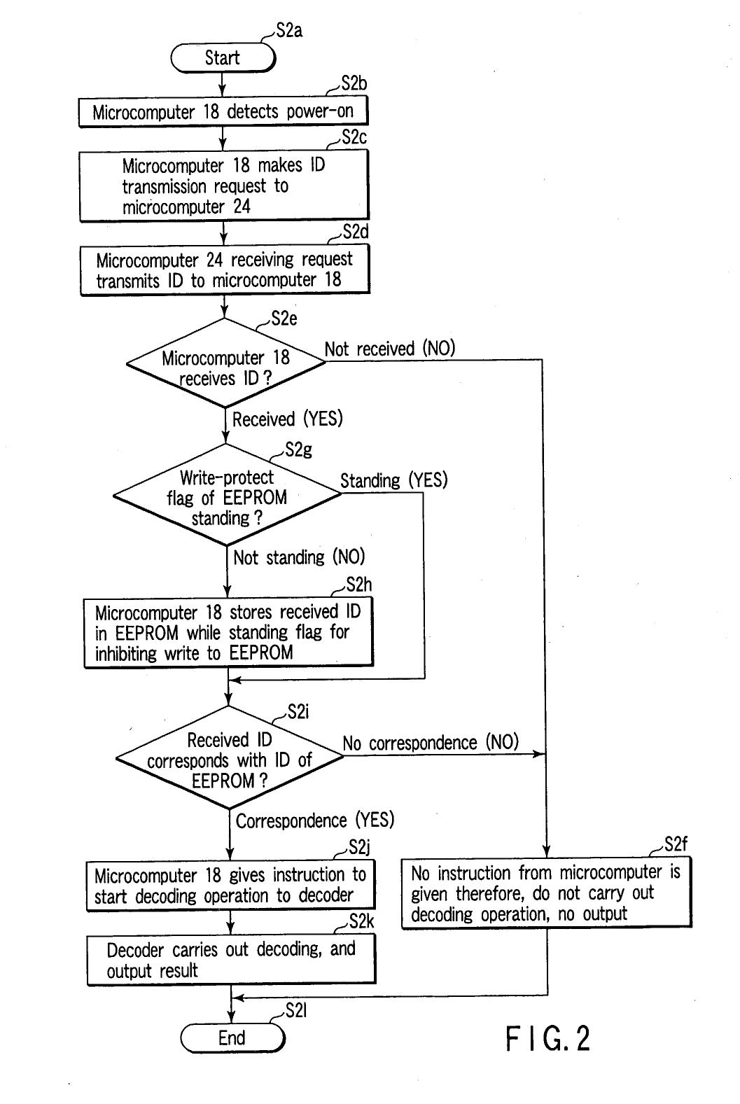

The following is a description of a way to prevent the above-described illegal alterations and conversions. FIG. 2 is a flowchart showing the mutual operation of the microcomputer 18 included in the copy-protect decoding module 12 and the microcomputer 24 included in the main unit 13.

When power is supplied to the sync device 11 to start it up (step S2a), the microcomputer 18 detects this in step S2b. In step S2c, the microcomputer 18 outputs an ID transmission request to the microcomputer 24. In this case, the ID is an identification number of a unique code allocated to the sync device 11, and previously stored in the microcomputer 24.

When receiving the above ID transmission request from the microcomputer 18, the microcomputer 24 sends the ID stored therein to the microcomputer 18 in step S2d. In step S2e, the microcomputer 18 determines whether or not the ID has been received. If it is determined that the microcomputer 18 has not received the ID, in step S2f, the microcomputer 18 makes no copy-protect decoding operation; therefore, the routine operation ends (step S21).

If the ID is received, the microcomputer 18 determines in step S2g whether or not a write-protect (inhibit) flag stands in the EEPROM 19 included in the copy-protect decoding module 12. The write-protect flag designates a specific address of the EEPROM 19. Whether write-protect is made is determined according to whether or not the write-protect flag is set or not.

Assume that the write-protect flag is not set initially. Therefore, the microcomputer 18 writes the received ID to the designated address of the EEPROM 19 in step S2h. By doing so, the ID unique to the sync device 11 given to the microcomputer 24 of the main unit 13 is transferred to the copy-protect decoding module 12 and stored therein. At the time the microcomputer 18 stores the received ID in the EEPROM 19, a flag for inhibiting the write into the EEPROM 19 is set.

The microcomputer 18 determines in step S2i whether or not the received ID corresponds to the ID stored in the EEPROM 19. If it is determined that correspondence is not made, the routine operation proceeds to step S2f.

If it is determined that correspondence is made, the microcomputer 18 gives an instruction to start a decoding operation to the copy-protect decoder 17 in step S2j. By doing so, in step S2k, the copy-protect decoder 17 carries out the decoding operation, and outputs the result to the main unit 13, thereafter, the routine operation ends (step S21).

When the power is turned on next, the operation is the same as the above first power-on operation in the flowchart of FIG. 2 until the microcomputer 18 receives the ID from the microcomputer 24. However, in this case, when the microcomputer 18 receives the ID and checks the write-protect flag of the EEPROM 19 in step S2g, the flag already stands. For this reason, the microcomputer 18 determines in step S2i whether or not the received ID corresponds with the ID stored in the EEPROM 19 without carrying out the write operation for a new write-protect flag in step S2h. The operation after that is the same as above.

Here, the following case will be corresponded. In order to make illegal copies, a malicious user opens the cabinet of the sync device 11 so that the copy-protect decoding module 12 can be detached, and installed into another recording device. In this case, even if the power supply to the module succeeds, when the user tries to operate the decoding module, the microcomputer 18 detects the power-on, thereafter, outputs an ID transmission request to the microcomputer 24.

However, the ID is not sent, or a non-correspondence ID (noise, etc.) is sent; for this reason, no instruction to start the decoding operation is given to the copy-protect decoder 17. Therefore, the copy-protect decoding operation is not carried out. The operation routine shown in FIG. 2 is referred to as routine A.

In the first embodiment, the EEPROM 19 has been used as the typical component for storing the ID. The memory built in the microcomputer 18 may be used in place of the EEPROM 19.

[Second Embodiment]

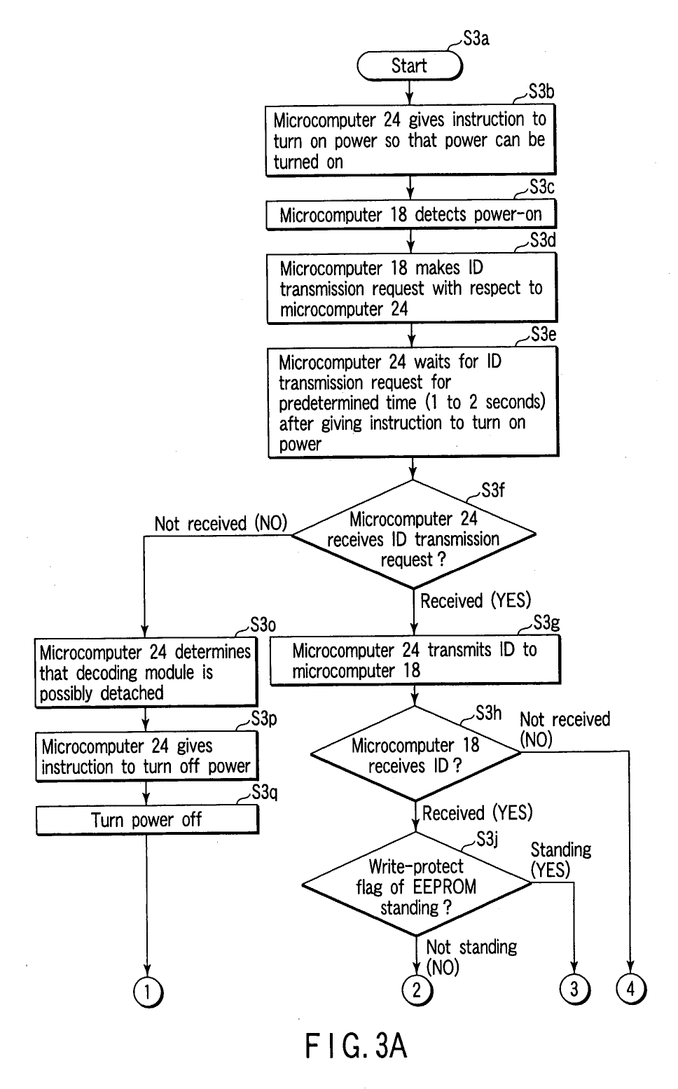

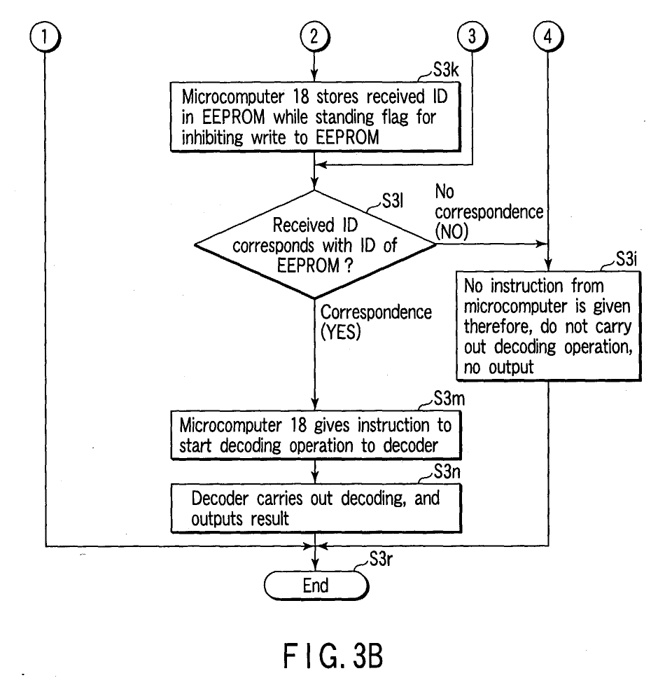

The following is a description on a second embodiment of the present invention. The second embodiment has the same configuration as the first embodiment. The operation will be described below with reference to flowcharts shown in FIG. 3A and FIG. 3B.

According to the second embodiment, the routine A of the first embodiment is intactly carried out, that is, the microcomputer 18 collates with the ID from the microcomputer 24, and thereby, permits the decoding operation by the copy-protect decoder 17. In addition to the above routine A, the microcomputer 24 detects the presence of the ID transmission request from the microcomputer 18, and thereby, confirms the existence of the copy-protect decoding module 12. Unless the existence is confirmed, the microcomputer 24 determines that the copy-protect decoding module 12 is detached, and turns off the power of the sync device 11.

The operation will be described below in detail with reference to FIG. 3A and FIG. 3B. Namely, the microcomputer 24 included in the main unit 13 is a microcomputer for controlling the sync device 11; therefore, the power of the sync device 11 is turned on according to the instruction from the microcomputer 24.

When the operation is started (step S3a), the microcomputer 24 gives the instruction to turn on the power of the entire sync device 11 in step S3b so that the power circuit 25 can turn on a set power supply. The microcomputer 18 detects the above power-on (step S3c), and outputs the ID transmission request to the microcomputer 24, as in the flow of FIG. 2 (step S3d).

In step S3e, the microcomputer 24 gives the instruction to turn on the set power supply, thereafter, waits for receiving the ID transmission request for a predetermined time (e.g., 1 or 2 seconds). If the ID transmission request is given within the predetermined time (step S3f), the same procedures as described in FIG. 2 are taken. Namely, steps S3g to S3n are the same as steps S2d to S2k shown in FIG. 2.

If it is determined in step S3f that the ID transmission request is not given within the predetermined time, the microcomputer 24 determines in step S3o that the copy-protect decoding module 12 is possibly detached. In step S3p, the microcomputer 24 gives the instruction to turn off the power to the power circuit 25, thereafter, in step S3q, forcedly turns off the set power supply, and thus, the operation ends (step S3r). The operation routine shown in FIG. 3A and FIG. 3B is referred to as routine B.

As seen from the above description, even if the copy-protect decoding module 12 is detached, the copy-protect decoding module 12 cannot be used in other devices, and in addition, the power of the sync device 11 is turned off. As a result, the sync device 11 is unusable. Therefore, this serves to deter illegal remodeling, and is expected to prevent illegal remodeling.

[Third Embodiment]

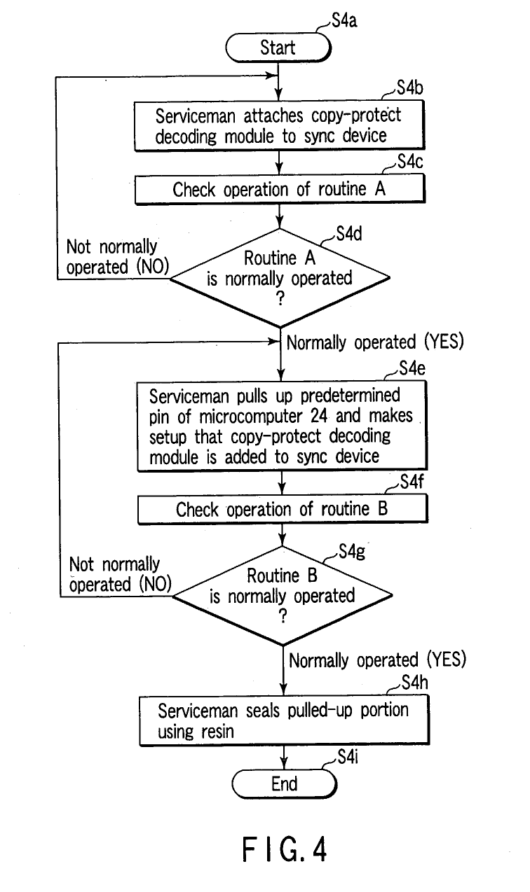

The third embodiment of the present invention will be described below with reference to FIG. 4. The third embodiment shows the case where the copy-protect decoding module 12 is attached as an after-sales option. FIG. 4 is a flowchart showing the procedures taken by a serviceman.

When the attachment is started (step S4a), the serviceman additionally attaches the copy-protect decoding module 12 to the sync device 11 from the back side in step S4b. In step S4c, the serviceman operates the sync device 11 so that the sync device carries out the routine A described in FIG. 2, and thereafter, confirms whether or not the sync device 11 is normally operated in step S4d.

In step S4e, the serviceman pulls up a predetermined pin of the microcomputer 24 included in the main unit 13 so as to effect setup relating to additional attachment of the sync device 11 to the copy-protect decoding module 12. Thereafter, in step S4f, the serviceman operates the sync device 11 so that the sync device carries out the routine B described in FIG. 3A and FIG. 3B. If it is confirmed in step S4g that the sync device 11 is normally operated, the serviceman fixes the pulled-up pin of the microcomputer 24 by a resin seal (step S4h), and thus, the procedure ends (step S4i). The pulled-up pin may be fixed using a bonding agent in place of the above resin seal.

[Fourth Embodiment]

The fourth embodiment of the present invention will be described below. According to the fourth embodiment, one feature is added to the above first to third embodiments, and thereby, illegal copy is more securely prevented.

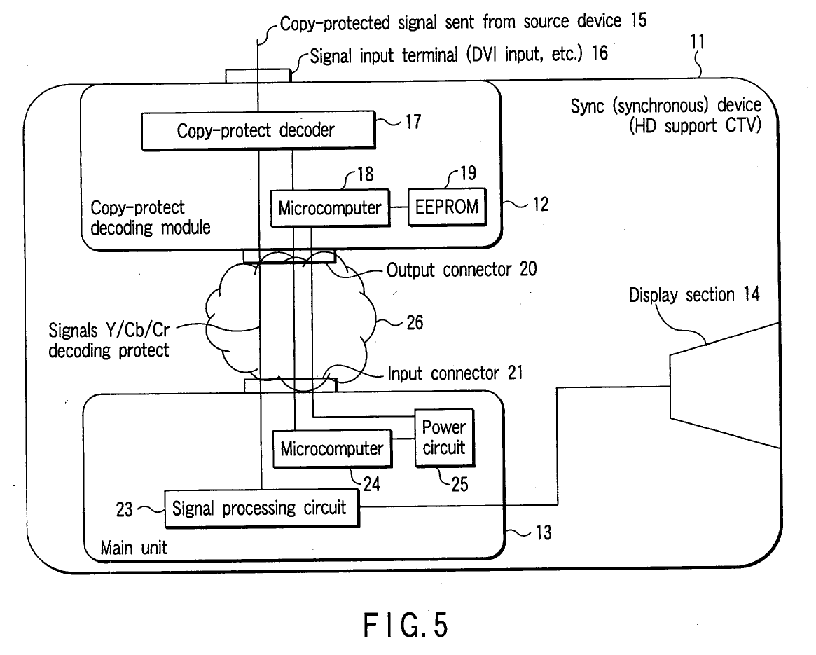

More specifically, as seen from FIG. 5, the portion connecting the copy-protect decoding module 12 and the main unit 13 are directly connected by the connectors 20 and 21 in place of the cable 22. The connecting portion between the connectors 20 and 21 is sealed by a resin 26, or covered with a bonding agent.

Likewise, in order to cover each substrate back surface of the module 12, and the main unit 13 on which the pin of the connectors 20 and 21 are soldered and exposed, the resin is sealed thereto, or a bonding agent is applied thereto. By doing so, the module 12 and main unit 13 are physically and firmly fixed; therefore, if these components are forcedly detached, mechanical breakdown occurs in any of the substrate, connector and main unit. As a result, it is possible to obtain the effect of preventing illegal copying.

In the above embodiments, the microcomputer 18 of the copy-protect decoding module 12 requests for and receives the ID data from the microcomputer 24 of the main unit 13. Instead, the microcomputer 24 of the main unit 13 may requests and receive the ID data from the microcomputer 18 of the copy-protect decoding module 12.

The present invention is not limited to the above embodiments, and various modifications may be made without departing from the spirit or scope of the invention.

What is claimed is:

1. An apparatus for regenerating a copy-protected signal, comprising:
a decoding module including a decoding section configured to decode a copy-protected signal, and a first control section configured to control the decoding section; and
a unit including a signal processing section configured to process a signal decoded by the decoding section, and a second control section configured to control the signal processing section,
the first control section permitting a decoding operation by the decoding section when the self-holding identification information corresponds to identification information preset in the second control section.

2. An apparatus according to claim 1, wherein the identification information held in the first control section includes information that the second control section supplies self-holding identification information to the first control section when the first control section makes a request to the second control section.

3. An apparatus according to claim 2, wherein the first control section holds the identification information received from the second control section in a non-rewritable state.

4. An apparatus according to claim 2, wherein the first control section requests identification information from the second control section when power is turned on, and the second control section supplies identification information to the first control section when a request from the first control section is made.

5. An apparatus according to claim 4, wherein the second control section sets the apparatus so that the power is forcedly turned off if no identification information request from the first control section is made within a predetermined time after the power is turned on.

6. An apparatus according to claim 1, further comprising:
connectors of the decoding module and the unit,
the connectors being directly connected with each other, the connected portion being sealed by a resin or bonding agent.

7. An apparatus for regenerating a copy-protected signal, comprising:
a decoding module including first means for decoding a copy-protected signal, and second means for controlling the first means; and
a unit including third means for processing a signal decoded by the first means, and fourth means for controlling the third means,
the second means permitting a decoding operation by the first means when identification information held in the second means corresponds to that preset in the fourth means.

8. An apparatus according to claim 7, wherein the identification information held in the second means includes information that the fourth means supplies self-holding identification information to the second means when the second means makes a request to the fourth means.

9. An apparatus according to claim 8, wherein the second means holds the identification information received from the fourth means in a non-rewritable state.

10. An apparatus according to claim 8, wherein the second means requests identification information from the fourth means when power is turned on, and the fourth means supplies identification information to the second means when a request from the second means is made.

11. An apparatus according to claim 10, wherein the fourth means sets the apparatus so that the power is forcedly turned off if no identification information request from the second means is made within a predetermined time after the power is turned on.

12. An apparatus according to claim 7, further comprising:
connectors of the decoding module and the unit,
the connectors being directly connected with each other, the connected portion being sealed by a resin or bonding agent.

13. A method of regenerating a copy-protected signal with respect to the apparatus comprising:
a decoding module including a decoding section configured to decode a copy-protected signal, and a first control section configured to control the decoding section; and
a unit including a signal processing section configured to process a signal decoded by the decoding section, and a second control section configured to control the signal processing section,
comprising:
detecting power-on of the apparatus so that one of the first and second control sections requests the other control section for identification information;
the other control section outputting identification information to said one control section in accordance with the identification information request; and
comparing the outputted identification information with identification information previously held in said one control section, and permitting a decoding operation when the former and the latter have correspondence.

14. A method according to claim 13, wherein when the other control section outputs identification information to said one control section, identification information obtained first is held in said one control section in a non-rewritable state.

15. A method according to claim 13, wherein the power of the apparatus is forcedly turned off if no identification information request from said one control section to the other control section is made within a predetermined time after the power is turned on.
